(19) United States
(12) Patent Application Publication
(10) Pub. No.: US 2026/0309911 A1
(43) Pub. Date: Oct. 8, 2026

(54) WAVEGUIDE TURNING MIRROR WITH TRANSVERSE EXTENSION

(71) Applicant: International Business Machines Corporation, Armonk, NY (US)

(72) Inventors: John Knickerbocker, Monroe, NY (US); Hsianghan Hsu, Latham, NY (US); Neng Liu, Albany, NY (US); Russell A. Budd, North Salem, NY (US); Mark D. Schultz, Ossining, NY (US); William GREEN, Irvington, NY (US); Daniel M. Kuchta, Patterson, NY (US); Laurent Schares, Pleasantville, NY (US)

(21) Appl. No.: 19/173,402

(22) Filed: Apr. 8, 2025

(51) Int. Cl. G02B 6/122; G02B 6/12

(52) U.S. Cl. CPC G02B 6/122; G02B 2006/12104

(57) ABSTRACT

An optical routing apparatus is provided including a first waveguide and a second waveguide, where the first waveguide directly contacts the second waveguide in an area adjacent to a waveguide turning mirror that has a transverse extension. The waveguide turning mirror with the transverse extension turns optical energy carried by a main waveguide core of either the first waveguide or the second waveguide and at least some portion of the optical energy carried by the cladding that surrounds the main waveguide core of the first waveguide or the second waveguide, coupling the first waveguide to the second waveguide.

### BACKGROUND

The present application relates to photonics, and more particularly to an optical routing apparatus including a waveguide turning mirror having a transverse extension which can provide increased bandwidth with ultra-low insertion loss.

An optical waveguide is a physical structure that guides electromagnetic waves in the optical spectrum. Common types of optical waveguides include optical fiber waveguides, transparent dielectric waveguides made of plastic and glass, liquid light waveguides and liquid waveguides. Optical waveguides are typically used as a component in integrated optical circuits or as the transmission medium on local and long-haul optical communication systems. Optical waveguides can be classified according to their geometry (e.g., planar, strip or fiber waveguides), mode structure (e.g., single mode or multimode), refractive index distribution (step or gradient index) and material (e.g., glass, polymer or semiconductor).

An optical waveguide includes a waveguide core (i.e., a longitudinally extended high-index optical medium) surrounded by cladding (low-index media) in the transverse direction. The waveguide core guides optical waves along its longitudinal axis.

### SUMMARY

An optical routing apparatus is provided including a first waveguide and a second waveguide, where the first waveguide directly contacts the second waveguide in an area adjacent to a waveguide turning mirror that has a transverse extension. The waveguide turning mirror with the transverse extension turns optical energy carried by a main waveguide core of at least one of the first waveguide or the second waveguide and at least some portion of the optical energy carried by the cladding that surrounds the main waveguide core of the first waveguide or the second waveguide, coupling the first waveguide to the second waveguide.

In one aspect of the present application, an optical routing apparatus is provided. In one embodiment of the present application, the optical routing apparatus includes a first waveguide including a first waveguide core with cladding of a lower refractive index than the first waveguide core; a second waveguide including a second waveguide core with cladding of a lower refractive index than the second waveguide core, the second waveguide core is oriented at a non-zero angle relative to the first waveguide core; and a turning mirror configured to turn optical energy carried by at least one of the first waveguide core or the second waveguide core and at least some portion of the optical energy carried by the cladding that surrounds the first waveguide core or the second waveguide core, coupling the first waveguide to the second waveguide.

In another aspect of the present application, a photonics structure is provided. The photonics structure includes an optical routing apparatus for routing optical energy within the photonics structure, the optical routing apparatus including a first waveguide including a first waveguide core with cladding of a lower refractive index than the first waveguide core; a second waveguide including a second waveguide core with cladding of a lower refractive index than the second waveguide core, the second waveguide core is oriented at a non-zero angle relative to the first waveguide core; and a turning mirror configured to turn optical energy carried by at least one of the first waveguide core or the second waveguide core and at least some portion of the optical energy carried by the cladding that surrounds the first waveguide core or the second waveguide core, coupling the first waveguide to the second waveguide.

In yet another aspect of the present application, a method of forming an optical routing apparatus is provided. The method includes forming a first waveguide core in a first cladding layer; forming a second cladding layer on top of the first waveguide core and the first cladding layer; forming an opening in the second cladding layer that physically exposes a portion of the first waveguide core; forming a waveguide stud portion (i.e., a lower portion of a second waveguide core) in the opening and contacting the first waveguide core; forming a slanted opening in the second cladding layer and the first cladding layer and adjacent to an area in which the first waveguide core contacts the waveguide stud portion; and forming a turning mirror in the slanted opening and adjacent to the area in which the first waveguide core contacts the waveguide stud portion.

### BRIEF DESCRIPTION OF THE DRAWINGS

FIG. 1 is a top down view of an optical routing apparatus in accordance with an embodiment of the present application, the optical routing apparatus including a first waveguide, a second waveguide and a turning mirror, where each of the first waveguide, the second waveguide, and the turning mirror is in a plane, and the turning mirror is at a 45° angle relative to a waveguide core of the first waveguide and a waveguide core of the second waveguide.

FIG. 2 is a top down view of an optical routing apparatus in accordance with an embodiment of the present application, the optical routing apparatus including a first waveguide, a second waveguide and a turning mirror, where each of the first waveguide, the second waveguide, and the turning mirror is in a plane, and the turning mirror is at arbitrary angle relative to a waveguide core of the first waveguide and a waveguide core of the second waveguide.

FIG. 3 is a three-dimensional (3D) perspective view of an optical routing apparatus in accordance with an embodiment of the present application, the optical routing apparatus including a first waveguide, a second waveguide and a turning mirror, where the waveguide core of the second waveguide is out of-plane relative to the waveguide core of the first waveguide.

FIG. 4 is a cross sectional view of an optical routing apparatus in accordance with an embodiment of the present application, the optical routing apparatus including a first waveguide, a second waveguide, a third waveguide, a first turning mirror and a second turning mirror, where the waveguide core of the second waveguide is substantially vertical to the waveguide core of the first waveguide and the third waveguide core of the third waveguide.

FIG. 5 is a cross sectional view of an optical routing apparatus in accordance with an embodiment of the present application, the optical routing apparatus including a first waveguide, a second waveguide, a third waveguide, a first turning mirror and a second turning mirror, where the waveguide core of the second waveguide is at an arbitrary angle with respect to the waveguide core of the first waveguide and the waveguide core of the third waveguide.

FIG. 6 illustrates a turning mirror surface located at a centerline of the intersection of a first waveguide and a second waveguide.

FIG. 7A illustrates a turning mirror surface located inboard of a centerline of the intersection of a first waveguide and a second waveguide.

FIG. 7B illustrates a turning mirror surface located on an outboard of a projected center intersection portion of a first waveguide core and a second waveguide core.

FIG. 8 illustrates added waveguide core material located adjacent to an inboard of a centerline of the intersection of a first waveguide and a second waveguide.

FIGS. 9A-9K are cross sectional views illustrating a method of forming a segment of an optical routing apparatus in accordance with an embodiment of the present application.

FIG. 10 is a cross sectional view of the exemplary structure shown in FIG. 9K forming an upper second waveguide core portion in a third cladding layer, where the upper second waveguide core portion is formed in contact with the waveguide stud portion illustrated in FIG. 9K and the upper second waveguide core portion and the waveguide stud portion collectively provide a second waveguide core.

FIGS. 11A-11B illustrate a fusion bonding process for forming an optical routing apparatus in accordance the present application, the optical routing apparatus including a first waveguide, a second waveguide, and a turning mirror, where the second waveguide is substantially vertical to the first waveguide.

### DETAILED DESCRIPTION

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

The terms substantially, substantially similar, about, or any other term denoting functionally equivalent similarities refer to instances in which the difference in length, height, or orientation convey no practical difference between the definite recitation (e.g., the phrase sans the substantially similar term), and the substantially similar variations. In one embodiment, substantial (and its derivatives) denote a difference by a generally accepted engineering or manufacturing tolerance for similar devices, up to, for example, 10% deviation in value or 10° deviation in angle.

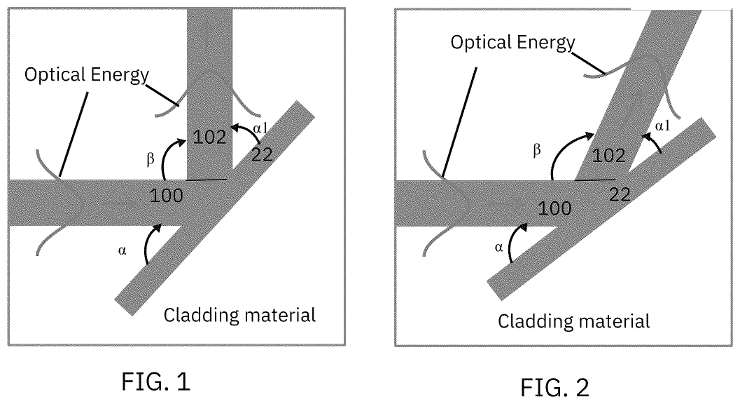

The present application is directed an optical routing apparatus/structure that provides increased bandwidth with ultra-low insertion loss and which can support low optical power interconnects. Notably, the present application provides an optical routing apparatus (such as, illustrated in FIGS. 1-5), which includes a first waveguide including a waveguide core (the waveguide core of the first waveguide is hereinafter referred to as first waveguide core 100) with cladding (e.g., cladding material as mentioned in FIGS. 1-5) of a lower refractive index than the first waveguide core 100; a second waveguide including a waveguide core (the waveguide core of the second waveguide is hereinafter referred to as second waveguide core 102) with cladding (e.g., cladding material as mentioned in FIGS. 1-5) of a lower refractive index than the second waveguide core 102, where the second waveguide core is oriented at a non-zero angle, β, relative to the first waveguide core 100; and a turning mirror 22 configured to turn optical energy carried by either the first waveguide core 100 or the second waveguide core 102 and at least some portion of the optical energy carried by the cladding that surrounds the first waveguide core 100 or the second waveguide core 102, coupling the first waveguide to the second waveguide. The turning of the optical energy depends on the direction of light flowing though the optical routing apparatus. For example and as illustrated in FIGS. 1-5, if light flows into the first waveguide prior to the second waveguide, turning mirror 22 turns the optical energy carried by the first waveguide core 100 and at least some portion of the optical energy carried by the cladding that surrounds the first waveguide core 100 to the second waveguide. If light flows into the second waveguide prior to the first waveguide (opposite that illustrated in FIGS. 1-5), turning mirror 22 is configured to turn the optical energy carried by the second waveguide core 102 and at least some portion of the optical energy carried by the cladding that surrounds the second waveguide core 102 to the first waveguide. By turning the optical energy of both the waveguide core and cladding that surrounds that waveguide core of one of the waveguides to the other waveguide insertion loss and certain reflections can be suppressed.

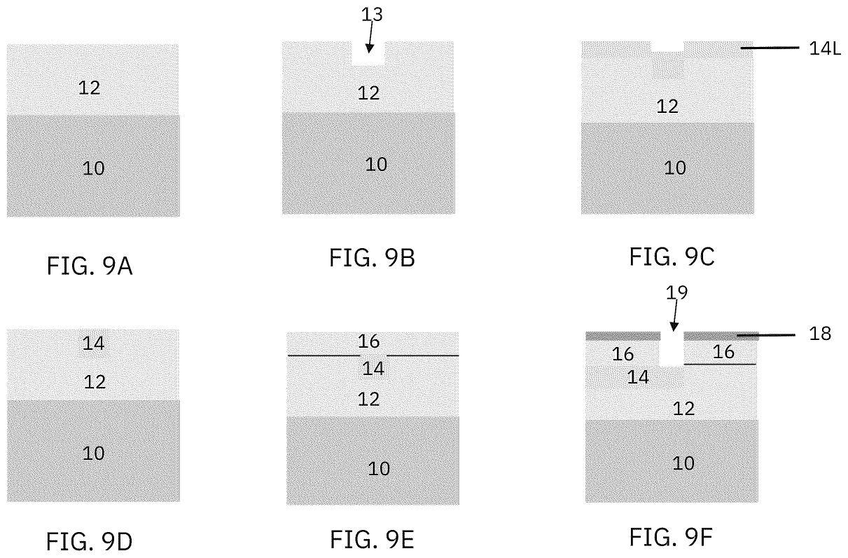

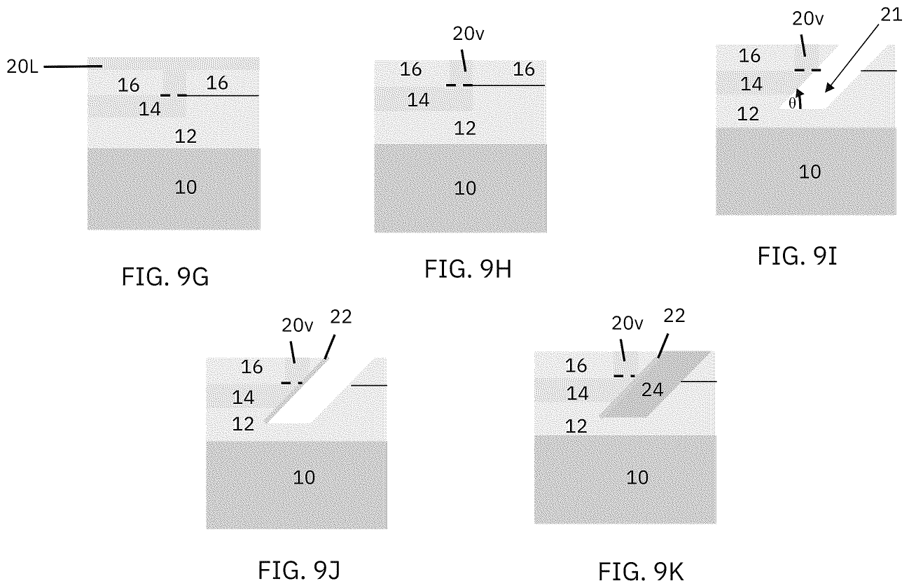

In the present application, the first waveguide core 100 and the second waveguide core 102 are composed of a compositionally same, or compositionally different, waveguide core material. Typically, the first waveguide core 100 and the second waveguide core 102 are composed of a same waveguide core material. The waveguide core material that provides the first waveguide core 100 and the second waveguide core 102 has a refractive index that is greater than the cladding that surrounds the waveguide core. Illustrative examples of waveguide core materials that can be used as the first waveguide core 100 and the second waveguide core 102 include, but are not limited to, silicon nitride (SiN), silicon oxynitride (SiON), silicon (Si) or a polymer. In some embodiments, the waveguide core material of both the first waveguide core 100 and the second waveguide core 102 is SiN. Further details regarding the waveguide core material that can be used in the present application will be provided in regard to the discussion of FIGS. 9A-9K.

The cladding that surrounds each of the first waveguide core 100 and the second waveguide core 102 includes a cladding material (or combination of cladding materials) having a refractive index that is less than the waveguide core material that provides the first waveguide core 100 and the second waveguide core 102. Illustrative examples of cladding materials that can be employed in the present application, include, but are not limited to, dielectric materials including, for example, silicon dioxide, polymers such as, for example, silicones, polysiloxanes, and silsesquioxanes, or composite or alternative material such as with a lower refractive index compared to the waveguide core. Further details regarding the cladding material that can be used in the present application will be provided in regard to the discussion of FIGS. 9A-9K.

The turning mirror 22 has a transverse extension, and is composed of a reflective material such as, for example, a metal, a stack of dielectric and/or semiconductor layers, a spin-coatable metal nanoparticle-impregnated polymer, or a composite structure such as with metal layer(s) and dielectric layer(s). By “transverse extension” it is meant that the turning mirror 22 has a portion that laterally extends away from a midline of the body of the turning mirror in a horizontal plane beyond the intersection of the mirror surface and the edge of a waveguide core. In accordance with the present application, the turning mirror 22 is larger than the cross-section of the waveguide core of the first waveguide or second waveguide at the angle of orientation. In some embodiments, the transverse extension extends beyond the first waveguide core 100 in more than one direction. Further details regarding the turning mirror 22 that can be used in the present application will be provided in regard to the discussion of FIGS. 9A-9K.

In the present application, the second waveguide core 102 is oriented at a non-zero angle, β, relative to the first waveguide core 100. Angle, β, can be from 5° to 175, with from 45° to 135° being more typical, and 90° being most typical. The first waveguide core 100 and the second waveguide core 102 can be oriented in a same plane, or out of-plane from each other.

In the present application, the turning mirror 22 is oriented at a non-zero angle, α, to the first waveguide core 100, and at a non-zero angle, α1, to the second waveguide core 102. In the present application, Angle, α, can be from 2° to 88°, with from 22° to 67° being more typical, and angle α1 can be from 2° to 88°, with from 22° to 67° being more typical and 45° being most typical.

In some embodiments, the first waveguide core 100 is located horizontally in a first cladding layer (see, first cladding layer 12 shown in FIG. 9F) of the cladding of the first waveguide and the second waveguide core 102 is oriented at an angle (not zero or 180°) not in a plane of the first cladding layer.

In some embodiments, the turning mirror 22 is larger than a cross-section of the first waveguide core 100 or a cross-section of the second waveguide core 102 at the angle of orientation.

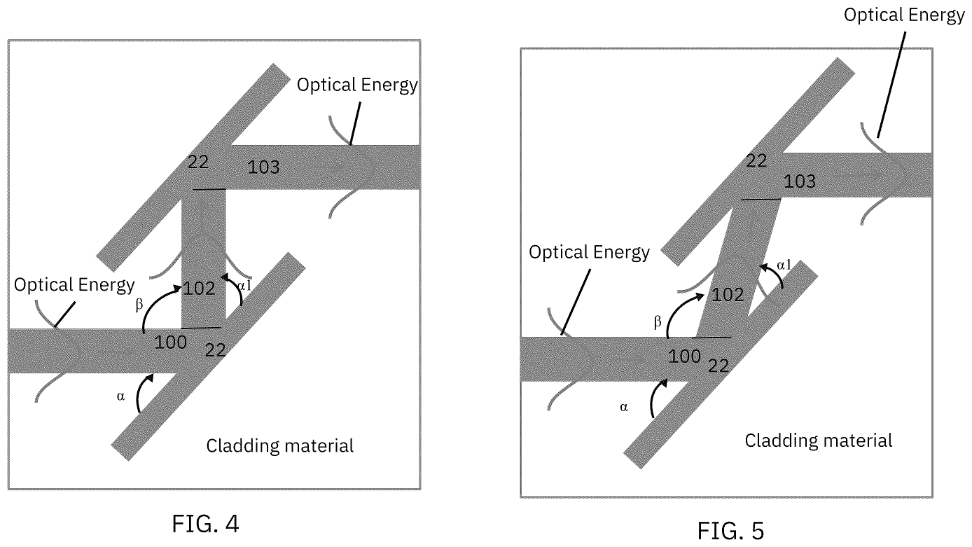

In some embodiments (such as, illustrated in FIGS. 4-5), the optical routing apparatus can further include a third waveguide including a third waveguide core 103 with cladding (similar to the cladding for the first waveguide core 100) of a lower refractive index than the third waveguide core 103, where the third waveguide core 103 transmits (i.e., travels) through a planar layer (e.g. third cladding layer 32 shown in FIG. 11) and the third waveguide core 103 is oriented at an angle not in plane of the planar layer.

In some embodiments, the second waveguide core 102 is located substantially vertical to a plane containing the first waveguide core 100.

These and other aspects of the present application will now be described in greater detail by referring to FIGS. 1-5. Referring first to FIG. 1, there is illustrated an optical routing apparatus in accordance with an embodiment of the present application. The optical routing apparatus illustrated in FIG. 1 includes first waveguide (including first waveguide core 100 and cladding the surrounds the first waveguide core 100), second waveguide (including second waveguide core 102 and cladding the surrounds the second waveguide core 102), and at least some portion of turning mirror 22. In this illustrated embodiment, each of the first waveguide, the second waveguide, and the turning mirror is in a plane, and the turning mirror 22 is at 45° relative to the first waveguide core 100 and the second waveguide core 102. That is, α, and α1 are each 45°. In this embodiment, angle, β, can 90°. In the illustrated embodiment shown in FIG. 1, light flows into the first waveguide prior to the second waveguide as is evidenced by the direction of the arrows in FIG. 1. As such, turning mirror 22 horizontally turns the optical energy carried by the first waveguide core 100 and at least some portion of the optical energy carried by the cladding that surrounds the first waveguide core 100 to the second waveguide.

Referring now to FIG. 2, there is illustrated an optical routing apparatus in accordance with an embodiment of the present application. The optical routing apparatus illustrated in FIG. 2 includes a first waveguide (including first waveguide core 100 and cladding the surrounds the first waveguide core 100), second waveguide (including second waveguide core 102 and cladding the surrounds the second waveguide core 102), and turning mirror 22. In the illustrated embodiment, the first waveguide, the second waveguide, and the turning mirror are in a plane, and the turning mirror is at arbitrary angle to the first waveguide core 100 and the second waveguide core 102. In the embodiment illustrated in FIG. 2, α can be from 10° to 80°, α1 can be from 10° to 80°, and β can be from 20° to 160°. In the illustrated embodiment shown in FIG. 2, light flows into the first waveguide prior to the second waveguide as is evidenced by the direction of the arrows in FIG. 2. As such, turning mirror 22 horizontally turns the optical energy carried by the first waveguide core 100 and at least some portion of the optical energy carried by the cladding that surrounds the first waveguide core 100 to the second waveguide.

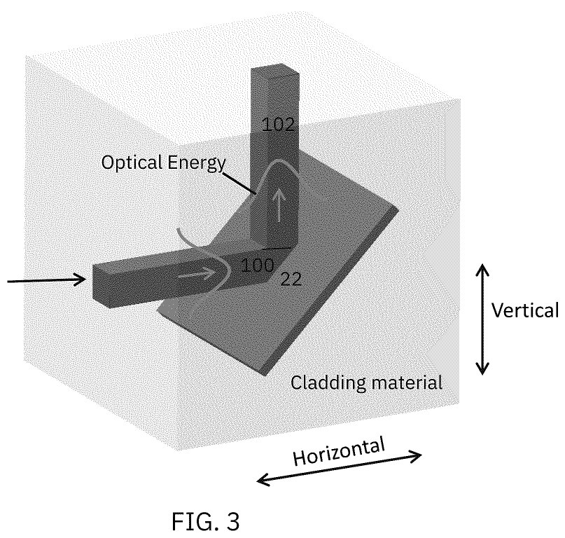

Referring now to FIG. 3, there is illustrated an optical routing apparatus in accordance with an embodiment of the present application. The optical routing apparatus illustrated in FIG. 3 includes first waveguide (including first waveguide core 100 and cladding the surrounds the first waveguide core 100), second waveguide (including second waveguide core 102 and cladding the surrounds the second waveguide core 102), and turning mirror 22. In this illustrated embodiment, the second waveguide core 102 is out of-plane relative to the first waveguide core 100. Notably, in this embodiment, the second waveguide core 102 is orientated vertically and the first waveguide core 100 is oriented horizontally. In the illustrated embodiment shown in FIG. 3, light flows into the first waveguide prior to the second waveguide as is evidenced by the direction of the arrows in FIG. 3. As such, turning mirror 22 turns the optical energy carried horizontally by the first waveguide core 100 and at least some portion of the optical energy carried by the cladding that surrounds the first waveguide core 100 to the second waveguide vertically.

In some embodiments (See, for example FIGS. 4 and 5), a third waveguide including a waveguide core (the waveguide core of the third waveguide is hereinafter referred to a third waveguide core 103) surrounded by cladding (e.g., cladding material as mentioned in FIGS. 4 and 5) of a lower refractive index than the third waveguide core 103. In such an embodiment, turning mirror 22 is present adjacent to an area in which second waveguide core 102 contacts the third waveguide core 103. In the illustrated embodiment, the first waveguide core 100 and the third waveguide core 103 are orientated horizontally, while the second waveguide core 102 is oriented vertically providing a vertical connection between the first waveguide core 100 and the third waveguide core 103. In such embodiments, turning mirror 22 that is adjacent to the area in which the second waveguide core 102 contacts the third waveguide core 103 turns optical energy carried either by the second waveguide core 102 or the third waveguide core 103 and at least some portion of the optical energy carried by the cladding that surrounds the second waveguide core 102 or the third waveguide core 103, coupling the second waveguide to the third waveguide. The third waveguide core 103 includes a waveguide core material as described above, and the cladding surrounding the third waveguide core includes a cladding material as described above. The waveguide core material that provides the third waveguide core 103 of the third waveguide can be compositionally the same ad, or compositionally different from, the waveguide core material that provides the first waveguide core 100 and/or the second waveguide core 102. Typically, the waveguide core material of the first waveguide core 100, second waveguide core 102, and third waveguide core 103 are compositionally the same (e.g., each is composed of SiN).

Referring now to FIG. 4, there is illustrated an optical routing apparatus in accordance with an embodiment of the present application. The optical routing apparatus illustrated in FIG. 4 includes a first waveguide (including first waveguide core 100 and cladding the surrounds the first waveguide core 100), second waveguide (including second waveguide core 102 and cladding the surrounds the second waveguide core 102), turning mirror 22 adjacent to an area in which the first waveguide core 100 is in contact with the second waveguide core 102, a third waveguide (including third waveguide core 103 and cladding the surrounds the third waveguide core 103) and turning mirror 22 located adjacent to an area in which the second waveguide core 102 contacts the third waveguide core 103. In this embodiment, α and α1 are both 45°, and β is 90°. Similar angles exist for the turning mirror 22 located adjacent to an area in which the second waveguide core 102 contacts the third waveguide core 103. In the illustrated embodiment shown in FIG. 4, light flows into the first waveguide prior to the second waveguide as is evidenced by the direction of the arrows in FIG. 4. As such, turning mirror 22 that is located adjacent to the connected first waveguide core 100 and the second waveguide core 102 vertically turns the optical energy carried by the first waveguide core 100 and at least some portion of the optical energy carried by the cladding that surrounds the first waveguide core 100 to the second waveguide, and turning mirror 22 that is located adjacent to the connected second waveguide core 102 and the third waveguide core 103 horizontally turns the optical energy carried by the second waveguide core 102 and at least some portion of the optical energy carried by the cladding that surrounds the second waveguide core 102 to the third waveguide.

Referring now to FIG. 5, there is illustrated an optical routing apparatus in accordance with an embodiment of the present application. The optical routing apparatus of FIG. 5 is similar to the one depicted in FIG. 4 except that the second waveguide core 102 is at an arbitrary angle with respect to the first waveguide core 100 and the third waveguide core 103. In the embodiment illustrated in FIG. 4, α can be from 10° to 80°, α1 can be from 10° to 80°, and β can be from 20° to 160°. Similar angles are associated with the second waveguide core 102, the third waveguide core 103 and the turning mirror 22 that is adjacent to the area of connection between the second waveguide core 102 and the third waveguide core 103. In the illustrated embodiment shown in FIG. 5, light flows into the first waveguide prior to the second waveguide as is evidenced by the direction of the arrows in FIG. 5. As such, turning mirror 22 that is located adjacent to the connected first waveguide core 100 and the second waveguide core 102 vertically turns the optical energy carried by the first waveguide core 100 and at least some portion of the optical energy carried by the cladding that surrounds the first waveguide core 100 to the second waveguide, and turning mirror 22 that is located adjacent to the connected second waveguide core 102 and the third waveguide core 103 horizontally turns the optical energy carried by the second waveguide core 102 and at least some portion of the optical energy carried by the cladding that surrounds the second waveguide core 102 to the third waveguide.

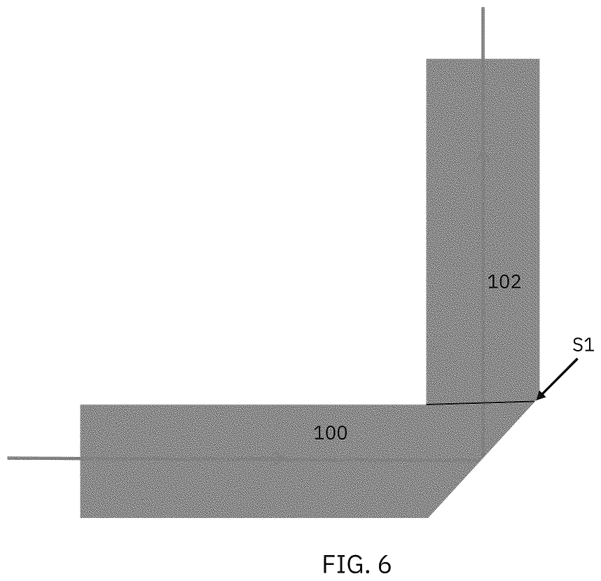

Referring now to FIG. 6, there is illustrated a turning mirror surface, S1, located at a centerline of the intersection of first waveguide core 100 and second waveguide core 102. This nominally centers the optical energy carried from one waveguide to the other on the top surface of the mirror. If all the energy were reflected exactly at the surface, this would provide optimal coupling. In most actual cases, the energy is reflected within a depth of the mirror, resulting in inefficient coupling for the case shown in FIG. 6.

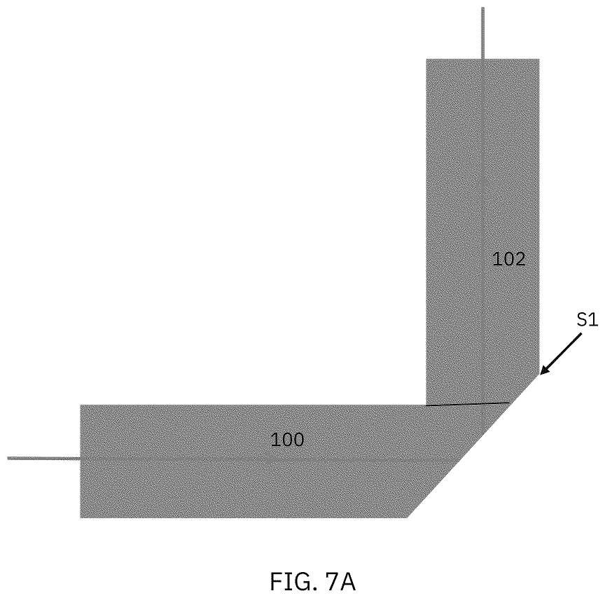

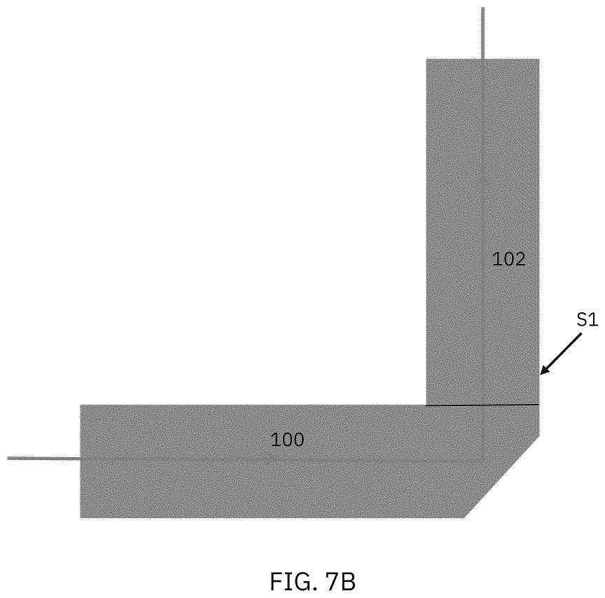

Referring now to FIG. 7A, there is illustrated a turning mirror surface, S1, located inboard of a centerline of the intersection of first waveguide core 100 and second waveguide core 102. Throughout the present application the term “inboard” is defined as an area inside of less than 180° angled defined by the intersection between two waveguide cores, i.e., the first waveguide core 100 and the second waveguide core 102. Moving the mirror surface inboard from where it is shown in FIG. 6 as shown in FIG. 7A will provide more efficient coupling for commonly used mirror materials such as, for example, silver (Ag). Referring now to FIG. 7B, there is illustrated a turning mirror surface, S1, located on an outboard of a projected center intersection portion of a first waveguide core 100 and a second waveguide core 102.

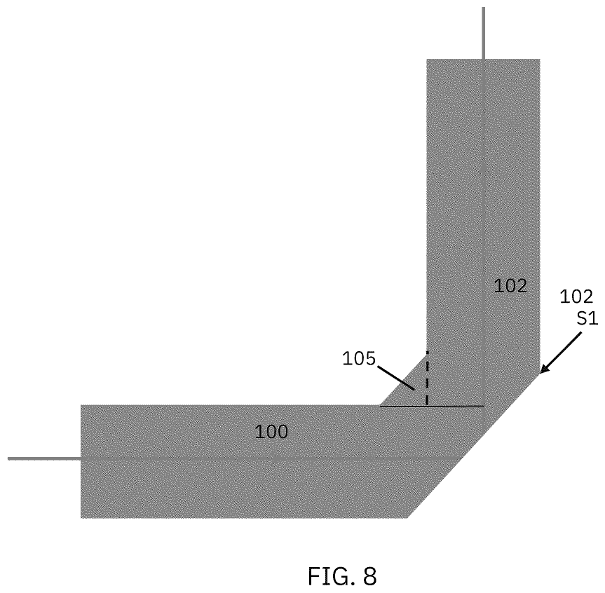

Referring now to FIG. 8, there is illustrated added waveguide core material 105 located adjacent to an inboard of a centerline of the intersection of first waveguide core 100 and second waveguide core 102. The added waveguide core material 105 can include one of the waveguide core materials mentioned herein. The added waveguide core material 105 can compositionally the same as, of compositionally different from, the waveguide core material of the two contacting waveguide cores, e.g., the first waveguide core 100 and the second waveguide core 102. Typically, the first waveguide core 100, the second waveguide core 102, and the added waveguide core material 105 are composed of SiN. The added waveguide core material 105 provides more efficient coupling of light carried between the two waveguides, as it assists in guiding the energy carried in one waveguide into the other.

Referring now to FIGS. 9A-9K, there are illustrated a method of forming a segment of an optical routing apparatus in accordance with an embodiment of the present application. The method begins by providing a first cladding layer 12 on a substrate 10 which may be a semiconductor substrate. The first cladding layer 12 can define a plane co-planer with the substrate plane. The substrate 10 can be composed of other materials besides a semiconductor material. In some embodiments, the first cladding layer 12 is formed directly on a surface of the substrate 10. In other embodiments, one or more material layers, particularly dielectric material layers, can be formed between the first cladding layer 12 and the substrate 10.

In some embodiments, the substrate 10 can include at least one semiconductor material having semiconducting properties. Examples of semiconductor materials that can be used in the present application include, but are not limited to, silicon (Si), a silicon germanium (SiGe) alloy, a silicon germanium carbide (SiGeC) alloy, germanium (Ge), III/V compound semiconductors or II/VI compound semiconductors. In some embodiments, substrate 10 is a bulk substrate that includes a single semiconductor material, or a stack of two or more semiconductor materials. In yet other embodiments, substrate 10 is a semiconductor-on-insulator substrate in which a dielectric layer (such as, for example, silicon dioxide and/or boron nitride) is sandwiched between a semiconductor base layer and a semiconductor device layer. The semiconductor base layer and the semiconductor device layer can be composed of a compositionally same semiconductor material (such as, for example, Si), or compositionally different semiconductor materials (such as Si and SiGe). Typically, an upper portion of the bulk substrate and the semiconductor device layer of the semiconductor-on-insulator substrate is composed of Si.

The first cladding layer 12 is composed of a dielectric material or a stack of dielectric materials and has a refractive index which is less than a refractive index of the waveguide core to be subsequently formed. The refractive index of the first cladding layer 12 is typically from 1 to 10, with a refractive index from 1 to 5 being more typical. Illustrative examples of dielectric materials that can be used as the first cladding layer 12 include, but are not limited to, dielectric oxides such as, for example, silicon dioxide, polymers such as, for example, silicones, polysiloxanes, and silsesquioxanes, or composite or alternative material such as with a lower refractive index compared to the waveguide core. The first cladding layer 12 can have a thickness from 500 nm to 5000 nm, although other thicknesses for the first cladding layer 12 are contemplated and can be employed in the present application. In some embodiments, the first cladding layer 12 can be formed on top of the substrate 10 by a deposition process including, for example, chemical vapor deposition (CVD), plasma enhanced chemical vapor deposition (PECVD), physical vapor deposition (PVD), atomic layer deposition (ALD), or spin coating. In other embodiments and when substrate 10 includes an uppermost semiconductor material layer, the first cladding layer 12 can be formed utilizing a thermal oxidation process in which an uppermost semiconductor material layer of the substrate 10 is oxidized to form a semiconductor oxide, e.g., silicon dioxide, which can be used as the first cladding layer 12.

Next, and as is illustrated in FIG. 9B, waveguide core channel 13 is formed in an upper portion of the first cladding layer 12. The waveguide core channel 13 is an opening that is partially formed into the first cladding layer 12 and is used in defining an area in which first waveguide core 14 will be subsequently formed therein. Note that FIG. 9B is an illustration along a width-wise direction of the waveguide core channel 13. The waveguide core channel 13 is formed by photolithography and etching. Photolithography includes forming a patterned resist (not shown) on the first cladding layer 12. The patterned photoresist can be composed of any conventional photoresist material(s). The patterned photoresist can be formed by deposition (e.g., CVD, PECVD, or spin-on coating) of a photoresist material(s), followed by exposing the as-deposited photoresist material(s) to a desired pattern of irradiation and then developing the exposed as-deposited photoresist material(s). With the patterned photoresist in place, the pattern in the patterned photoresist is then transferred into the first cladding layer 12 by etching so as to form the waveguide core channel 13. Etching can include a dry etch (such as, for example, reactive ion etching (RIE), ion beam etching (IBE), activated IBE or plasma etching), or a wet etch (i.e., an etch in which a chemical etchant is used). After forming the waveguide core channel 13, the patterned resist is removed from the first cladding layer 12 by a conventional material removal process such as, for example, resist stripping. The waveguide core channel 13 has a length and width.

After forming the waveguide core channel 13, a first waveguide core layer 14L is formed inside the waveguide core channel 13 and on top of the first cladding layer 12 providing the exemplary structure shown in FIG. 8C. First waveguide core layer 14L is composed of a waveguide core material having a refractive index that is greater than the first cladding layer 12. The waveguide core material that provides the waveguide core layer 14L has refractive index from 1 to 10, with a refractive index from 1 to 5 being more typical. The waveguide core material that provides the first waveguide core layer 14L can include, for example, SiN, SiON, Si or a polymer. In some embodiments, the first waveguide core layer 14L is composed of SiN, and the first cladding layer 12 is composed of silicon dioxide. The first waveguide core layer 14L can be formed by a deposition process such as, for example, CVD, PECVD, ALD, or spin coating of the waveguide core material.

Next, and as shown in FIG. 9D, a planarization process such as, for example, chemical mechanical planarization (CMP), can be used to remove the first waveguide core layer 14L that is located on top of the first cladding layer 12, while maintaining the first waveguide core layer 14L in the waveguide core channel 13. The first waveguide core layer 14L that is maintained in the waveguide core channel 13 can be referred to a first waveguide core 14 (note that first waveguide core 14 can represent first waveguide core 100 mentioned above). The first waveguide core 14 is a horizontal waveguide core. The first waveguide core 14 has a length and width that is determined by the length and width, respectively, of the waveguide core channel 13.

After forming the first waveguide core 14, a second cladding layer 16 is formed as shown in FIG. 9E. The second cladding layer 16 includes a dielectric material having a refractive index which substantially matches (or entirely matches) the refractive index of the dielectric material that provides the first cladding layer 12. Illustrative examples of dielectric materials that can be used as the second cladding layer 16 include dielectric oxides such as, for example, silicon dioxide, or polymers such as, for example, silicones, polysiloxanes, and silsesquioxanes. The second cladding layer 16 can have a thickness from 300 nm to 3000 nm, although other thicknesses for the second cladding layer 16 are contemplated and can be employed in the present application. The second cladding layer 16 can be formed by a deposition process including, for example, CVD, PECVD, PVD, ALD, or spin coating. In the illustrated embodiment, the first waveguide core 14 is surrounded by the first cladding layer 12 and the second cladding layer 16 and collectively, the first waveguide core 14, the first cladding layer 12 and the second cladding layer 16 form a first waveguide of the present application. In the illustrated embodiment, the first waveguide is a horizontal waveguide.

Next, and as shown in FIG. 9F (cross sectional view along the length-wise direction of first waveguide core 14), an opening 19 is formed in the second cladding layer 16 that physically exposes a surface of the first waveguide core 14. The opening 19 is located near one of the ends of the first waveguide core 14. The opening 19 can be formed by first forming a patterned mask 18 on the second cladding layer 16. The patterned mask 18 is composed of a masking material or stack of masking materials that are well known to those skilled in the art. In some embodiments in which a photoresist material is used in providing the patterned mask 18, the patterned mask 18 can be formed by lithography as defined above. In other embodiments in which a hard mask dielectric material is employed, the patterned mask 18 can be formed by deposition of a hard mask material, followed by patterning the as-deposited hard mask material by lithographic patterning. After forming the patterned mask 18 on the second cladding layer 16, an etch is used to form the opening 19 into the second cladding layer 16. The etch used in providing the opening 19 can include a dry etching process as described above. Opening 19 is employed in the present application to form a waveguide stud portion of a second waveguide core.

After forming opening 19 in the second cladding layer 16, the patterned mask 18 is removed from on top of the second cladding layer 16 utilizing a material removal process such as, for example, resist stripping or planarization (e.g., CMP). Next, and as shown in FIG. 9G, a second waveguide core layer 20L is formed inside the opening 19 and on top of the second cladding layer 16. Second waveguide core layer 20L is composed of a waveguide core material having a refractive index that is greater than the second cladding layer 16 and the first cladding layer 12. The waveguide core material that provides the second waveguide core layer 20L has refractive index from 1 to 10, with a refractive index from 1 to 5 being more typical. The waveguide core material that provides the second waveguide core layer 20L can include, for example, SiN, SiON, Si or a polymer. The waveguide core material that provides the second waveguide core layer 20L can be compositionally the same, or compositionally different, from the waveguide core material that provides the first waveguide core layer 14L. Typically, the second waveguide core layer 20L is composed of a compositionally same waveguide core material as the first waveguide core layer 14L. In one example, the second waveguide core layer 20L and the first waveguide core layer 14L are both composed of SiN. The second waveguide core layer 20L can be formed by a deposition process such as, for example, CVD, PECVD, ALD, or spin coating.

Next, and as illustrated in FIG. 9H, a planarization process such as, for example, CMP, is employed to remove the second waveguide core layer 20L that is present on top of the second cladding layer 16, while maintaining the second waveguide core layer 20 inside the opening 19. The planarization stops on a surface of the second cladding layer 16. The second waveguide core layer 20 that is maintained inside opening 19 can be referred to herein a waveguide stud portion 20v. The waveguide stud portion 20v will be used as a component of a second waveguide core that will be formed after formation of the turning mirror 22. The waveguide stud portion 20v lands on a surface of the first waveguide core 14 in an area adjacent to an area in which turning mirror 22 will be subsequently formed. The waveguide stud portion 20v has a height that is substantially equal to the thickness of the second cladding layer 16. The waveguide stud portion 20v is used as a lower portion of a second waveguide core.

After waveguide stud portion 20v formation, a slanted opening 21 is formed as is shown in FIG. 9I. The slanted opening 21 is formed through the second cladding layer 16, a lower portion of the first waveguide core 14, and an upper portion of the first cladding layer 12. The slanted opening 21 can also be formed through a lower portion of the waveguide stud portion 20v. The slanted opening 21 has an angle θ as measured from a sub-surface of first cladding layer that is physically exposed at the bottom of the slanted opening 21 to a slanted sidewall located adjacent to the first waveguide core 14 of from 10° to 80°, with angle θ being more typically from 40° to 50°. In some embodiments, the slanted opening 21 can be formed by focus ion beam (FIB) etch. The FIB etch sputters atoms from the surface that is being etched. In other embodiments, the slanted opening 21 can be formed by micromachining. In other embodiments, angled etching process such as, for example, an angled RIE process can be used in forming the slanted opening 21. It is noted that the slanted opening 21 undercuts the first waveguide core 14.

After forming the slanted opening 21, turning mirror 22, as illustrated in FIG. 9J, is formed along the sidewall of the slanted opening 21 that is located nearest the area in which the first waveguide core 14 and the waveguide stud portion 20v contact each other. The turning mirror 22 can be composed of a reflective material such as, for example, a metal, a stack of dielectric and/or semiconductor layers, a spin-coatable metal nanoparticle-impregnated polymer, or a composite structure such as with metal layer(s) and dielectric layer(s). When a metal is employed, the metal is a reflective metal such as, for example, gold (Au), silver (Ag), copper (Cu), titanium (Ti), tantalum (Ta), tungsten (W) or platinum (Pt). When a stack of dielectric layers are employed, the stack of dielectric layers includes at least two dielectric layers that are composed of a reflective dielectric materials that are compositionally different from each other. Examples of stack of dielectric layers that can be employed in the present application, include, but are not limited to, silicon (Si), silicon dioxide (SiO₂), silicon nitride (SiN), germanium (Ge), tantalum oxide (Ta₂O₅), or a polymer. The turning mirror 22 can be formed by a deposition process such as, for example, CVD, ALD, sputtering, or spin coating. A planarization process such as, for example, CMP, can follow the turning mirror 22 deposition process.

The turning mirror 22 that is formed has a transverse extension that extends above and below the first waveguide core 14. This transverse extension facilitates the turning mirror 22 capability of reflecting light in both the vertical and horizontal direction depending on the incident path of the light being transmitted through the waveguide core. Notably, the transverse extension facilitates the turning mirror 22 ability to turn optical energy carried by, for example, the first waveguide core 14 and at least some portion of the optical energy carried by the first cladding layer 12 and the second cladding layer 16. The transverse extension may extend beyond the waveguide core into and out of the plane of FIG. 9 as well.

The turning mirror 22 has an angled surface that is located adjacent to an area of intersection of the first waveguide core 14 and the waveguide stud portion 20v having an angle as measured from the base of the turning mirror to the curved surface that is substantially equal to angle θ mentioned above. The angled surface of the turning mirror can be a substantially smooth surface with a surface roughness from 0 Angstroms to 100 Angstroms peak to valley. A substantially smooth surface for the angled surface facilitates less light scattering.

After forming the turning mirror 22, the remaining volume of the slanted opening 21 is filled with a backfill material 24 providing the exemplary structure shown in FIG. 9K. The backfill material 24 can be composed of a semiconductor material such as, for example, Si, or a cladding material having a refractive index which substantially matches (or entirely matches) the refractive index of the cladding material that provides the first cladding layer 12 and/or second cladding layer 16. The backfill material 24 can be formed by deposition (e.g., CVD, PECVD, ALD, or spin coating) of a specific backfill material, and thereafter planarizing (e.g., CMP), the as-deposited backside material.

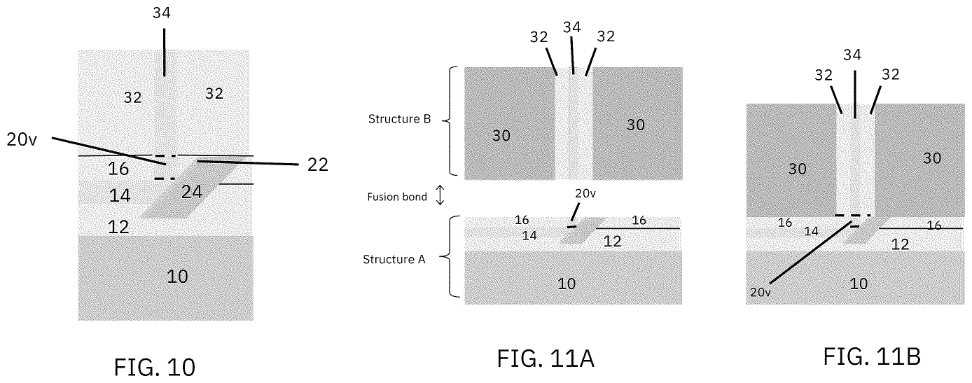

Referring now to FIG. 10, there is illustrated the exemplary structure shown in FIG. 9K after forming an upper second waveguide core portion 34 in a third cladding layer 32, where the upper second waveguide core portion 34 is formed in contact with the waveguide stud portion 20v and the upper second waveguide core portion 34 and the waveguide stud portion 20v collectively provide a second waveguide core (i.e., second waveguide core 102 mentioned above). In this embodiment, the second waveguide core is orientated substantially vertical to the first waveguide core 14.

The exemplary optical routing structure shown in FIG. 10 can be formed by first forming a third cladding layer 32 on physically exposed surfaces of the exemplary structure shown in FIG. 9K. The third cladding layer 32 includes a dielectric material having a refractive index which substantially matches (or entirely matches) the refractive index of the dielectric material that provides the first cladding layer 12 and/or the second cladding layer 16. Illustrative examples of dielectric materials that can be used as the third cladding layer 32 include dielectric oxides such as, for example, silicon dioxide, or polymers such as, for example, silicones, polysiloxanes, and silsesquioxanes. The third cladding layer 32 can have a thickness from 300 nm to 3000 nm, although other thicknesses for the third cladding layer 32 are contemplated and can be employed in the present application. The third cladding layer 32 can be formed by a deposition process including, for example, CVD, PECVD, PVD, ALD, or spin coating.

After providing the third cladding layer 32, an opening (not shown) is formed through the third cladding layer 32 that physically exposes the waveguide stud portion 20v. The opening can be formed by photolithography and etching. After forming the opening, the opening within the third cladding layer 32 is filled with a waveguide core material as mentioned above providing the upper second waveguide core portion 34. The waveguide core material that provides the upper second waveguide core portion 34 can be compositionally the same as, or compositionally different from, the waveguide core material that provides the waveguide stud portion 20v. Typically, the upper second waveguide core portion 34 is composed of a compositionally same waveguide core material as the waveguide stud portion 20v. The filling of the opening with the waveguide core material includes a deposition process such as, for example, CVD, PECVD, ALD, or spin coating, followed by a planarization process (e.g., CMP). In this embodiment, the second waveguide includes the waveguide stud portion 20v, the upper second waveguide core portion 34, the second cladding layer 16 and the third cladding layer 32.

The processing described above in forming the first waveguide, turning mirror 22 and second waveguide can be repeated as many times as desired to form a multi-leveled optical routing structure having a plurality of intersecting horizontal and vertical waveguide cores in which turning mirror 22 is present in an area adjacent to the interconnection between each horizontal and vertical waveguide core pair.

Referring now to FIGS. 11A-11B, there is illustrated a fusion bonding process for forming an optical routing apparatus in accordance the present application, the optical routing apparatus including a first waveguide, a second waveguide, and turning mirror 22, where the second waveguide is substantially vertical to the first waveguide. Notably, FIG. 11A illustrates vertical alignment of a second structure over a first structure. The second structure includes upper second waveguide core portion 34 that is laterally surrounded by third cladding layer 32 and a semiconductor material layer 30 laterally surrounding the third cladding layer 32. The first structure is the exemplary structure shown in FIG. 9K. In this embodiment, vertical alignment is achieved when the upper second waveguide core portion 34 is substantially vertical aligned over the waveguide stud portion 20v.

The second structure can be formed by forming a cavity partially through a base semiconductor substrate that is composed of one of the semiconductor materials mentioned above. The cavity can be formed by photolithography and etching. Third cladding layer 32 is then formed in the cavity and on top of the base semiconductor substrate utilizing a deposition process as mentioned above in forming the third cladding layer 32. In this embodiment, the third cladding layer 32 is formed along a sidewall and a bottom wall defined by the cavity; the third cladding layer does not fill in an entire volume of the cavity. A layer of waveguide core material as mentioned above for the upper second waveguide core portion 34 is then formed (by a deposition process) on top of the third cladding layer and filling the remaining volume of the cavity. A planarization process (e.g., CMP) is then used to remove the third cladding layer 32 and the layer of waveguide core material that is present outside the cavity and on the topmost surface of the base semiconductor substrate, while maintaining the third cladding layer 32 and the layer of waveguide core material in cavity. The layer of waveguide core material that is maintained in the cavity can be referred as the upper second waveguide core portion 34. The resultant structure including the upper second waveguide core portion 34 is then attached to a carrier wafer (not shown), and then a surface of the upper second waveguide core portion 34 opposite the carrier wafer is revealed by a material removal process (such as, for example, grinding or CMP) that removes a portion of the semiconductor base substrate and the third cladding layer 32. The remaining portion of the semiconductor base layer is referred as the semiconductor material layer 30. Note that carrier wafer (which is not illustrated in FIG. 11A for clarity) is removed after fusion bonding.

After alignment of the second structure of the first structure, the two structure are brought into intimate contact with other and thereafter a fusion bonding anneal is performed to fusion bond the first and second structure together forming the optical routing structure illustrated in FIG. 11B.

Although not shown, additional layers can be formed above the structure shown in FIG. 11B. Notably, the processing described above in forming the first waveguide, turning mirror 22 and second waveguide can be repeated as many times as desired to form a multi-leveled optical routing structure having a plurality of intersecting horizontal and vertical waveguide cores in which turning mirror 22 is present in an area adjacent to the interconnection between each horizontal and vertical waveguide core pair. In some embodiments, a second fusion bonding process can be used to form a third structure similar to the one illustrated in FIG. 9K on top the second structure. In such an embodiment, another structure such as shown in FIG. 9K is attached to a carrier wafer, and the aligned above over the second structure such that the waveguide stud portion 20v of the another structure shown in FIG. 9K. The second and third structures are brought into intimate contact and a second fusion bonding process can be formed. In this embodiment, the turning mirror of the another structure after the second bonding process is inverted relative to the turning mirror shown in FIG. 9K.

Although the above describes embodiments in which the turning mirror 22 is formed after forming the first waveguide core 14, the present application contemplates embodiments in which the turning mirror 22 is formed prior to the first waveguide core 14. In such embodiments, the turning mirror 22 can be formed utilizing grayscale lithography to create slope/curvature to a resist scaffold which can then be transferred by RIE, or by isotropic etching of a silicon dioxide layer to create a silicon dioxide structure having a curved surface. The curved surface of the silicon dioxide structure can then be metalized forming a turning mirror that can be used in the present application.

In addition to the above processes that describe the formation of an horizontal waveguide connected to a vertical waveguide, the present application also provides optical routing structures such as shown in FIGS. 1A-1B in which two waveguides are orientated in a same plane as the turning mirror. In such optical routing structures, the two waveguide can be formed utilizing conventional waveguide processes and the turning mirror can be formed as described above.

In addition to the above processes that describe the formation of a single first waveguide and a single second waveguide, the processes above can be used in forming a plurality of first waveguides and second waveguides. For example, a third waveguide can be formed utilizing the same procedure as mentioned above for the first waveguide and a fourth waveguide can be formed utilizing the same procedure as mentioned above for the second waveguide.

The optical routing apparatus can be used as a component of a photonics structure where it can be integrated with other structures such as, for example, one or more semiconductor chips, which are typically employed in photonics.

While the present application has been particularly shown and described with respect to preferred embodiments thereof, it will be understood by those skilled in the art that the foregoing and other changes in forms and details may be made without departing from the spirit and scope of the present application. It is therefore intended that the present application not be limited to the exact forms and details described and illustrated, but fall within the scope of the appended claims.

What is claimed is:

1. An optical routing apparatus comprising
a first waveguide comprising a first waveguide core with cladding of a lower refractive index than the first waveguide core;
a second waveguide comprising a second waveguide core with cladding of a lower refractive index than the second waveguide core, the second waveguide core is oriented at a non-zero angle relative to the first waveguide core; and
a turning mirror configured to turn optical energy carried by at least one of the first waveguide core or the second waveguide core and at least some portion of the optical energy carried by the cladding that surrounds the first waveguide or the second waveguide, coupling the first waveguide to the second waveguide.

2. The optical routing apparatus of claim 1, wherein the first waveguide core is located horizontally in, or on, a first cladding layer of the cladding of the first waveguide and the second waveguide core is oriented at an angle not in a plane of the first cladding layer.

3. The optical routing apparatus of claim 1, wherein the turning mirror is larger than a cross-section of the first waveguide core or a cross-section of the second waveguide core at the angle of orientation.

4. The optical routing apparatus of claim 2, further comprising a third waveguide comprising a third waveguide core with cladding of a lower refractive index than the third waveguide core, wherein the third waveguide core transmits through a planar layer and the third waveguide core is oriented at an angle not in plane of the planar layer.

5. The optical routing apparatus of claim 2 wherein the second waveguide core is located substantially vertical to a plane containing the first waveguide core.

6. The optical routing apparatus of claim 1, wherein the turning mirror has a turning mirror surface located inboard of a projected center intersection point of the first waveguide core and the second waveguide core.

7. The optical routing apparatus of claim 1, wherein the turning mirror has a turning mirror surface located outboard of a projected center intersection point of the first waveguide core and the second waveguide core.

8. The optical routing apparatus of claim 1, further comprising additional waveguide core material located adjacent an inboard intersection point of the first waveguide core and the second waveguide core.

9. The optical routing apparatus of claim 8, wherein the first waveguide core, the second waveguide core, and the additional waveguide core material are composed of silicon nitride.

10. The optical routing apparatus of claim 1, wherein the turning mirror is located adjacent to an area in which the first waveguide core contacts the second waveguide core.

11. The optical routing apparatus of claim 1, wherein the turning mirror has a transverse extension that laterally extends away from a midline of a body of the turning mirror in a horizontal plane beyond intersection of a mirror surface and an edge of the at least one of the first waveguide core or the second waveguide core.

12. The optical routing apparatus of claim 1, wherein the turning mirror comprises a metal, a stack of dielectric materials and/or semiconductor layers, a spin-coatable metal nanoparticle-impregnated polymer, or a composite structure with metal layer(s) and dielectric layer(s).

13. The optical routing apparatus of claim 1, wherein the first waveguide core and the second waveguide core are both composed of silicon nitride.

14. The optical routing apparatus of claim 13, wherein the cladding is composed of silicon dioxide.

15. A photonics structure comprising:
optical routing apparatus for routing optical energy within the photonics structure, the optical routing apparatus comprising:
a first waveguide comprising a first waveguide core with cladding of a lower refractive index than the first waveguide core;
a second waveguide comprising a second waveguide core with cladding of a lower refractive index than the second waveguide core, the second waveguide core is oriented at a non-zero angle relative to the first waveguide core; and
a turning mirror configured to turn optical energy carried by either the first waveguide core or the second waveguide core and at least some portion of the optical energy carried by the cladding that surrounds the first waveguide or the second waveguide, coupling the first waveguide to the second waveguide.

16. A method of forming an optical routing apparatus, the method comprising:
forming a first waveguide core in a first cladding layer;
forming a second cladding layer on top of the first waveguide core and the first cladding layer;
forming an opening in the second cladding layer that physically exposes a portion of the first waveguide core;
forming a waveguide stud portion in the opening and contacting the first waveguide core;
forming a slanted opening in the second cladding layer and the first cladding layer and adjacent to an area in which the first waveguide core contacts the waveguide stud portion; and
forming a turning mirror in the slanted opening and adjacent to the area in which the first waveguide core contacts the waveguide stud portion.

17. The method of claim 16, further comprising forming a backfill material in a remaining volume of the slanted opening and in contact with the turning mirror.

18. The method of claim 16, wherein the slanted opening is formed by a focus ion beam (FIB) etch, micromachining or an angled etch process.

19. The method of claim 16, wherein the turning mirror has a transverse extension.

20. The method of claim 16, further comprising forming an upper second waveguide core portion in contact with the waveguide stud portion, wherein the upper second waveguide core portion in contact with the waveguide stud portion collectively provide a second waveguide core, the second waveguide core is oriented at an angle to the first waveguide core.
